(19) United States
(12) Patent Application Publication
(10) Pub. No.: US 2004/0195780 A1
(43) Pub. Date: Oct. 7, 2004

(54) Back pumping seal assembly

(76) Inventors: Jeff Baehl, Fort Wayne, IN (US); Larry J. Castleman, New Haven, IN (US)

Correspondence Address: RANDALL J. KNUTH P.C., 3510-A STELLHORN ROAD, FORT WAYNE, IN, 46815-4631, US

(21) Appl. No.: 10/805,540

(22) Filed: Mar. 19, 2004

Related U.S. Application Data
(60) Provisional application No. 60/460,143, filed on Apr. 3, 2003.

(51) Int. Cl. F16J 15/32

(52) U.S. Cl. 277/549

(57) ABSTRACT

A back pumping seal assembly includes a buffer seal and a backup ring. The buffer seal has inner, outer, front, and back seal faces. The buffer seal further has a contoured face portion inset and extending inwardly from the inner and back seal faces. The contoured face defines a back seal channel. The backup ring is positioned in the back seal channel of the buffer seal. The backup ring includes inner and back ring faces, and at least two channel-directed faces. The inner and back ring faces are adjacent the inner and back seal faces, respectively. A first channel-directed face extends from the inner ring face substantially parallel to the back ring face. The first channel-directed face is configured for limiting displacement of an adjacent portion of the buffer seal. A second channel-directed face extends from the back ring face at an acute angle relative thereto.

### CONTINUING DATA

This application hereby claims the benefit under Title 35, United States Codes § 119 (e) of any U.S. application serial No. 60/460,143 filed Apr. 3, 2003, and is hereby incorporated by reference.

### BACKGROUND OF THE INVENTION

1. Field of the Invention

The present invention relates to an improved seal assembly which includes a buffer seal and a backup ring which are together configured to relieve pressure primarily through back pumping.

2. Description of the Related Art

Seal elements are commonly utilized in machines having parts which move relative to one another and which include fluid (i.e., a liquid and/or a gas) which is to be retained in a specific portion of the machine. Seal elements may additionally be utilized between static members of machines in situations in which a fluid is to be kept within a certain portion thereof. One of the machine parts typically includes a gland (i.e., a groove and/or a channel) which is designed to house the sealing element. Examples of such seals include annular seals utilized in hydraulic mechanisms to seal between the piston and the cylinder of the hydraulic mechanism. In these configurations, the gland may be formed in the piston or the cylinder of the hydraulic element.

Such seal systems typically require a means for pressure relief as the pressure between the buffer seal and the downstream element of the assembly, furthest away from the pressure seal, increases with an increase in pressure generated by the machine. In the prior art, the sealing systems are designed so as to provide a pressure flow relief path that is directed around the outer diameter of the buffer seal element (i.e., the outer diameter face of the buffer seal being directed toward the gland and away from the seal region between the seal assembly and the corresponding machine member). However, it has been found that a valve which relies upon such an outer diameter flow path presents issues with respect to reliability. The outer diameter bypass of such a system is difficult to maintain due to the tendency of the cup design of the buffer seal to collapse and due to the tendency of the seal cross-section to rotate, whereby the outer diameter lip then seals against the groove or gland side wall.

What is needed in the art is a seal assembly which provides a more efficient and reliable fluid pressure relief path than that offered by the outer diameter bypass and that simultaneously provides improved pressure relieving characteristics.

### SUMMARY OF THE INVENTION

The present invention, in one form thereof, comprises a back pumping seal assembly including a buffer seal and a backup ring. The buffer seal has an inner seal face, an outer seal face, a front seal face, and a back seal face. The buffer seal further has a contoured face portion inset and extending inwardly from the inner seal face and the back seal face. The contoured face defines a back seal channel. The backup ring is positioned in the back seal channel of the buffer seal. The backup ring includes an inner ring face, a back ring face, and at least two channel-directed faces. The inner ring face and the back ring face are adjacent the inner seal face and the back seal face, respectively. A first channel-directed face extends from the inner ring face in a direction substantially parallel to the back ring face. The first channel-directed face is configured for limiting displacement of a portion of the buffer seal position adjacent thereto. A second channel-directed face extends from the back ring face at an acute angle relative thereto.

The present invention, in another form thereof, comprises a machine assembly including a first machine member, a second machine member, and a back pumping seal assembly. The first machine member has an outer surface associated therewith. The second machine member has a member receiving opening therein, the first machine member being mounted within the member receiving opening. The second machine member further has a seal receiving channel therein, the seal receiving channel extending inwardly into the second machine member from a location within the member receiving opening. The back pumping seal assembly is operatively positioned within the seal receiving channel. The back pumping seal assembly creates a working seal between the first machine member and the second machine member. The back pumping seal assembly advantageously includes all those features set forth in the above-description of the first form of this invention.

One advantage of the present invention is that the backup ring provides support to the seal during both low and high pressure actuation by providing an initial clearance between the inner diameter of the backup ring and the outer diameter of the adjacent machine part. This clearance provides an area or distance for some displacement of the backup ring, thereby permitting the absorption of energy in a manner that reduces the overall contact forces of the sealing elements, reducing frictional forces therebetween in the process.

Another advantage of the present invention is that the seal assembly provides an improved contact stress profile for the sealing lip of the primary sealing component (i.e., the buffer seal) by providing support to the sealing lip in the area opposite pressure. Such an improved contact stress profile of the sealing lip yields improved back pumping characteristics.

A further advantage of the present invention is that, for high-pressure applications, the cross-sectional shape of the backup ring can be configured to provide for a tilting and/or rotation of the cross-section. Such a cross-section can be chosen so as to provide optimal extrusion resistance for the adjacent portion the primary seal member yet also maintain the optimal contact stress profile in the area of the backup ring.

A yet further advantage of the present invention is that the inner diameter surface of the backup ring is constructed with some angularity (typically less than 10° relative to the outer diameter of the adjacent machine part) so as to provide an optimal interface to induce the fluid film necessary for back pumping.

An even yet another advantage of the present invention is that the backup ring extends under the primary seal component to the extent that the primary seal lip is raised off of the sealing surface by the inter-stage pressure between the primary seal component and the backup ring (i.e., an interference fit further exists therebetween) to further relieve the pressure associated with the seal assembly.

In a related manner, the cross-section of the primary seal is chosen such that the stiffness of the primary seal is reduced by the formation a hinge therein which facilitates pressure relief via the inner diameter of the seal assembly, thereby providing a more reliable seal valve than the typical design which provides this valve function around the outer diameter lip of the seal assembly.

An additional advantage of the present invention is that this seal design technique can be applied to multiple applications, not just linear fluid power systems. The friction reduction achieved with such a system can potentially be very useful for applications that have high surface velocities or in other (e.g., vibratory) applications where seal surface heat generation becomes detrimental. The improved back pumping along with the pressure relieving characteristics of the seal assembly of the present invention can potentially improve the performance of many common seal designs.

A further advantage of the present invention is that it is designed to be used in a system that includes either a downstream seal (secondary seal) or a suitable wiper (in any case either element must provide a suitable fluid film control).

A further advantage of the present invention is that such a system can be used with all fluid types including air and can be used in a variety of dynamic situations. It can be used in machine applications having rotary, reciprocating, and/or oscillatory motion, e.g., in shaft, piston seal, or face seal arrangements.

### BRIEF DESCRIPTION OF THE DRAWINGS

The above-mentioned and other features and advantages of this invention, and the manner of attaining them, will become more apparent and the invention will be better understood by reference to the following description of various embodiments of the invention taken in conjunction with the accompanying drawings, wherein:

FIGS. 1A-1C are partially schematic, cross-sectional views of the operation of a first embodiment of a back pumping seal assembly of the present invention within a machine assembly;

FIGS. 2A-2C are partially schematic, cross-sectional views of a second embodiment of a back pumping seal assembly of the present invention acting under varying degrees of pressure within a machine assembly; and

FIGS. 3-7 are cross-sectional views of further embodiments of the back pumping seal assembly of the present invention.

Corresponding reference characters indicate corresponding parts throughout the several views. The exemplifications set out herein illustrate at least one preferred embodiment of the invention, in one form, and such exemplifications are not to be construed as limiting the scope of the invention in any manner.

### DETAILED DESCRIPTION OF THE INVENTION

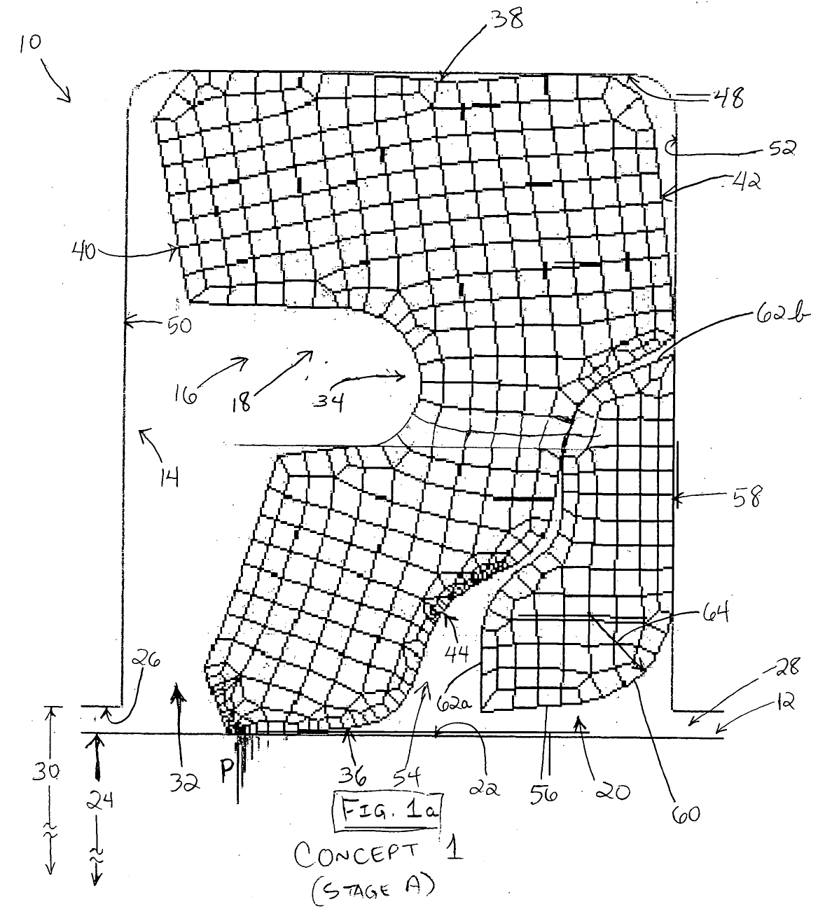

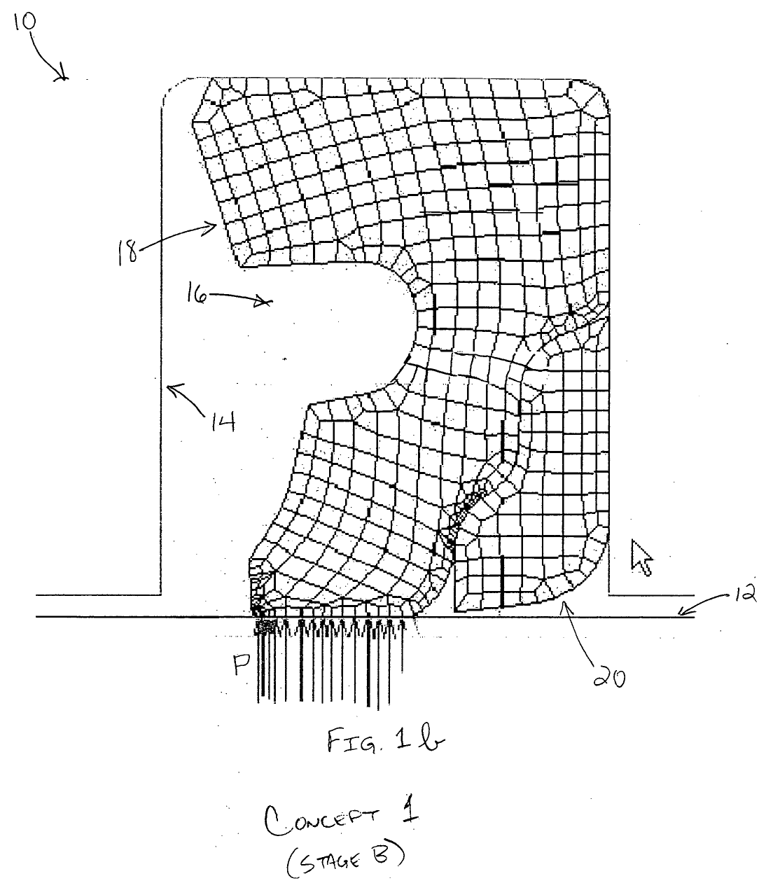

As shown in the two embodiments illustrated in FIGS. 1A-1C and FIGS. 2A-2C, respectively, the present invention generally discloses a machine assembly 10 having a first machine member 12, a second machine member 14, and a back pumping seal assembly 16. Back pumping seal assembly 16 includes a buffer seal 18 and a backup ring 20.

Machine assembly 10 is typically used to generate rotary, reciprocating, and/or oscillatory motions in a shaft, piston seal, and/or face seal arrangement. While machine 10 as shown in the first two embodiments is configured for providing linear fluid power, other types of machines having high surface velocities between relative moving parts and/or other applications, where seal surface heat generation becomes detrimental, are also within the scope of the present invention. It is further contemplated that machine assembly 10 could employ the back pumping seal assembly 16 of the present invention to create a seal between essentially static parts.

In the two embodiments shown in FIGS. 1A-1C and FIGS. 2A-2C, first machine member 12 is a linear member (e.g., a cylinder) such as a piston that is configured for relative linear movement with respect to second machine member 14 in which it is housed. First machine member 12 has an outer surface 22 and an outer diameter 24 (schematically indicated). Further, second machine member 14 has a primary inner surface 26 defining a member receiving channel or opening 28. Member receiving channel or opening 28 has an associated inner diameter 30 which is chosen so as to be greater than outer diameter 24 of first machine member 12 to permit receipt of first machine member 12 within member receiving channel or opening 28. However, there is a definite limit, to the degree to which the inner diameter 30 can exceed the outer diameter 24, as a reasonably close fit of the first machine member 12 within member receiving channel or opening 20 is necessary in order to achieve efficient relative linear motion between first and second machine members 12 and 14. Seal assembly 16 aids in maintaining this desired controlled clearance between machine parts 12 and 14, and thereby helps to avoid and/or minimize the amount of frictional contact that would otherwise occur between first and second machine members 12 and 14. (As mentioned previously, the seal assembly is primarily provided to retain a fluid in specific location relative to machine parts 12 and 14.)

Second machine member 14 is provided with a seal receiving channel or gland therein for receiving back pumping seal assembly 16. Seal receiving channel or gland 32 (which may also be considered to be in the form of a groove) extends inwardly into second machine member 14 from a location within member receiving channel or opening 28. In general, a back pumping seal assembly 16 will be sized so as to extend out of seal receiving gland 32 and beyond primary inner surface 26 of second machine member 14 and into at least partial contact with outer surface 22 of first machine member 12, the amount of contact therebetween increasing with the amount of pressure P applied therebetween (a concept which is illustrated in FIGS. 1A-1C and FIGS. 2A-2C).

Back pumping seal assembly 16 advantageously extends substantially around the entirety of first machine member 12 to maximize both the sealing achieved therewith and to help maintain the relative positioning of first machine member 12 to second machine member 14. Back pumping seal assembly 16 will generally be annular and/or polygonal in shape so as to generally match the cross-sectional shape of first machine member 12.

Buffer seal 18 is advantageously composed of a material that is more elastic than that used for backup ring 20. Specifically, the preferred material for buffer seal 18 is an elastomer. The low stiffness exhibited by buffer seal 18 (i.e., the primary seal component) facilitates pressure relief adjacent outer surface 22 of first machine member 12. To further reduce the stiffness associated therewith, buffer seal 18 is provided with an integral hinge section 34.

Buffer seal 18 generally includes an inner seal face 36, an outer seal face 38, a front seal face 40, a back seal face 42, and a contoured face portion 44.

Included as part of front seal face 40 is concave hinge surface 46. Associated with hinge section 34. Inner seal face 36 is positioned adjacent outer surface 22 of first machine member 12, while outer seal face 38 is opposite thereto and directed inwardly toward a surface 48 of seal receiving channel or gland 32. Meanwhile, front seal face 40, which includes concave hinge surface portion 46, is generally directed toward the upstream side 50 of seal gland 32. Conversely, back seal face 42 is at least partially in contact with downstream side 52 of seal gland 32, the amount of contact therebetween increasing with the amount of pressure applied to back pumping seal assembly 16. Furthermore, contoured face portion 44 is inset and extends inwardly from inner seal face 36 and back seal face 42 to thereby define a back seal channel 54 for receiving backup ring 20.

Backup ring 20 is generally positioned adjacent to and in contact with downstream side 52 of seal receiving gland 32. Backup ring 20 is advantageously made of a material that is both stiffer and stronger than that used for buffer seal 18. An example of a material suitable for use for backup ring 20 is polytetrafluoroethylene (PTFE) although other materials, composites, or matrixes may be utilized. Backup ring 20 generally includes an inner ring face 56, a back ring face 58, a chamfered corner ring surface 60, and a plurality of channel-directed faces 62. A first such channel-directed face 62a extends from the inner ring face 56 in a direction substantially parallel to both back ring face 56 and downstream side 52 of gland 32. First channel-directed face 62a also is generally perpendicular to outer surface 22 of first machine member 12. A second channel-directed face 62b extends inwardly from back ring face 58 at an acute angle relative thereto.

Various characteristics associated with inner ring face 56 contribute to the effectiveness of backup ring 20 and its role within back pumping seal system 16. Under no-to-low load or pressure conditions, a clearance exists between at least a portion of inner ring face 56 and outer surface 22 of first member 12. This clearance provides an area or distance for some displacement of the backup ring 20 during pressure application. This displacement provides an absorption energy via hoop stress. This absorption of energy reduces the overall contact forces of the sealing elements, thereby reducing frictional forces associated therewith. The same technique provides an improved contact stress profile for the inner seal face 36 (i.e., the sealing lip) of buffer seal 18 by providing support to inner seal face 36 in the area opposite pressure. This improved contact stress profile of inner seal face 36 provides improved back pumping characteristics. To optimize the contact stress interface between backup ring 20 and outer surface 22 of first machine member 12, inner ring face 56 should be constructed with some angularity, advantageously an angle of greater than 0° and less than about 10° relative to outer surface 22 of first machine member 12, and, likewise, at an acute angle of about 80° or more relative to first channel-directed face 62a.

First channel-directed face 62a, by being essentially perpendicular to outer surface 22 of first machine member 12 and by being of sufficient depth, is configured to provide optimal extrusion resistance for buffer seal 18 and yet maintain the optimal stress profile in the area of the backup ring by essentially limiting deformation of buffer seal 18 relative to backup ring 20. Specifically, once buffer seal 18 is in complete contact with channel-directed face 62a, deformation of buffer seal 18 is then limited to regions above first channel-directed face 62a. As a result of the deformation characteristics associated with this configuration, backup ring 20 is increasingly urged downward into contact with outer surface 22 of first machine member 12 as sealing pressure increases. Such displacement improves the back pumping characteristics of the seal assembly 16 and permits the backup ring 20, which is made of the stronger material relative to buffer seal 18, to thereby accommodate a greater amount of the force associated with the increased pressure on seal assembly 16.

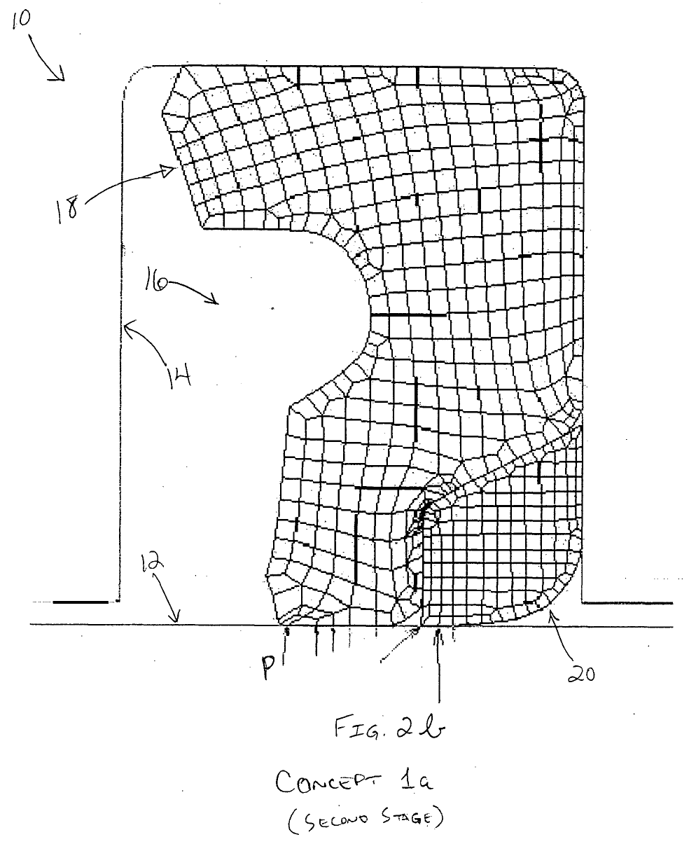

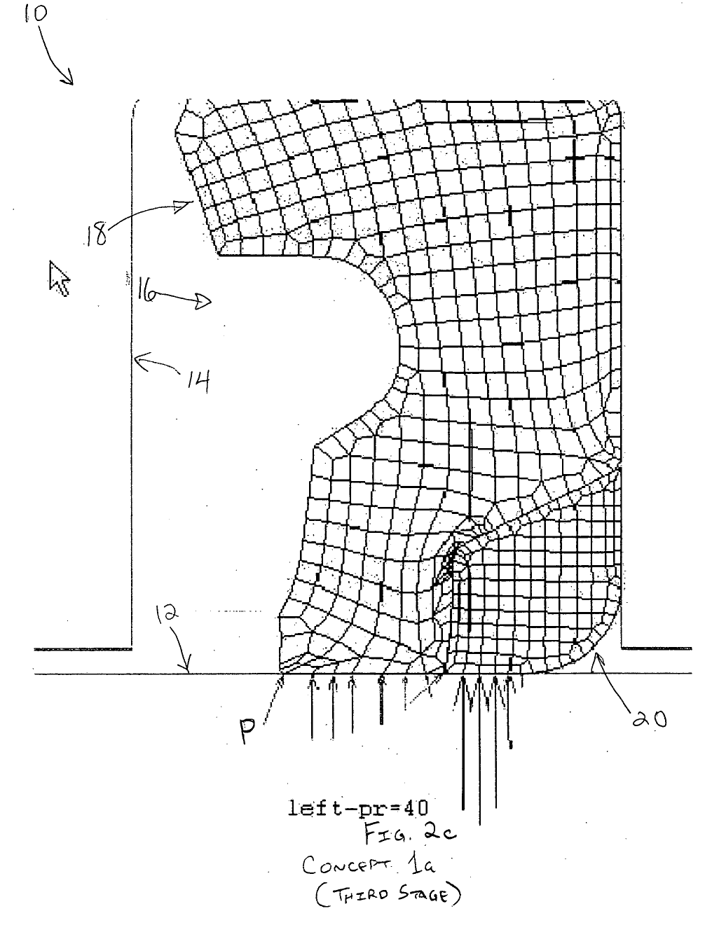

Backup ring 20 has a geometry that provides for a tilting or rotation of the cross-section thereof. In each of the embodiments shown (FIGS. 1A-1C, 2A-2C, and 3-7) backup ring 20 is thicker near back ring face 58 than proximate first channel-directed face 62a. This thickening of the downstream portion of backup ring 20 helps to maintain the optimal contact stress profile in the area of the backup ring. Specifically, the thicker section of the backup ring 20 resists the deformation caused by pressure applied thereto, therefore promoting a rotation of the backup ring geometry.

Chamfered corner ring surface 60 has an associated chamfered radius 64, this radial portion of backup ring 20 being opposite the direction of pressure application relative to seal assembly 16 (i.e., chamfered corner ring surface is proximate downstream side 52 of seal gland 32). Chamfered corner ring surface 60 provides an optimal interface to induce the fluid film necessary for back pumping. Additionally, the radial nature of surface 60 further promotes the tilting and/or rotation of the backup ring cross-section under high pressure applications.

The provision of one or more channel-directed faces 62 (e.g., face 62b) that are generally angled upwardly in a direction approaching back ring face 58 is another advantageous feature of backup ring 20. Such face angulation promotes a relative slippage between buffer seal 18 and backup ring 20, thereby at least partially relieving part of the applied pressure. Additionally, such an angled face causes a part of the lateral displacement forces associated with buffer seal 18 to be converted to a vertical force component which biases backup ring 20 toward outer surface 22 of first machine member 12, thereby allowing the stronger backup ring 20 to accommodate a portion of the forces otherwise associated with buffer seal 18.

It can be advantageous for clearances to exist between some or all of channel-directed faces 62 and contoured face portion 44 under no-to-low pressure or load conditions. Such clearances can be obtained by differences in angularity of adjacent surface portions of buffer seal 18 and backup ring 20, differences in size between backup ring 20 and back seal channel 54, and/or simply to the displacement of backup ring 20 from buffer seal 18 within back seal channel 54. In a manner similar to that discussed previously, the lateral displacement that is able to occur within buffer seal 18 before buffer sal 18 comes into complete contact with an adjacent channel-directed face 62 of backup ring 20 effectively at least partially relieves the pressure placed upon buffer seal 18.

The geometry of backup ring 20 is integral in the pressure relieving function of seal assembly 16. This is accomplished by having the backup ring 20 extend under buffer seal 18 (the primary seal component) and into back seal channel 54 to the extent that the inner seal face 36 is raised at least partially off of outer surface 22 of first machine member 12 by the inter-stage pressure and/or interference fit between at least a portion of backup ring 20 with buffer seal 18 in back seal channel 54.

Due to the presence of concave hinge surface portion 46 in each of the various embodiments of buffer seal 18 (all Figs.), such configurations for buffer seal 18 are generally referred to as cup designs. In such cup designs of the present invention, the amount that backup ring 20 extends into back seal channel 54 advantageously overlaps with the pressure cavity of the primary seal cavity of buffer seal 18. The combination of overlap this and the reduction in stiffness of buffer seal 18 gained via hinge section 34 facilitates pressure relief via the inner surfaces 36 and 56 associated with seal assembly 16. This configuration provides a more reliable valve than the typical design that provides the valve function around the outer seal face/outer diameter lip of that typical seal assembly. The outer diameter valve bypass is difficult to maintain due to collapse of the cup design in rotation of the seal cross-section where the outer diameter lip then seals against the groove sidewall.

The operation of the seal embodiments shown in FIGS. 1A and 2A effectively, is shown in stages of increasing pressure application within FIGS. 1A-1C and FIGS. 2A-2C. From these figures, it can be seen and understood how buffer seal 18 and backup ring 20 move with respect to each other and with respect to machine members 12 and 14 as pressure is increased within machine assembly 10. The applied pressure P is schematically shown as in each of these drawings, the number and relative size of the arrows indicating the relative force/pressure distribution at various stages of pressure application.

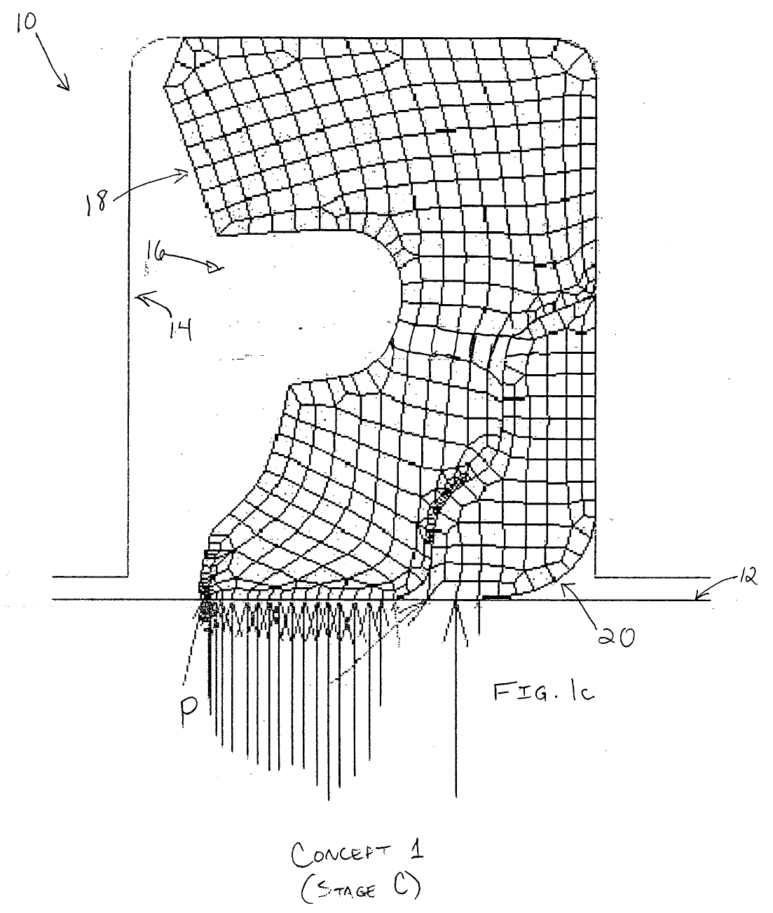

Further embodiments of back pumping seal assembly 16 are illustrated in FIGS. 3-7. These embodiments each employ various seal assembly features that have been previously discussed. As such, the discussion with respect to FIGS. 3-7 will be essentially limited to details which are peculiar to the embodiments shown in FIGS. 3-7.

In each of FIGS. 3-7, at least a portion of backup ring 20 will form an interference contact with buffer seal 18, once placed in position under an initial pressure within a seal receiving channel or gland 32 of a second machine member 14. In the embodiment shown in FIGS. 3, 5, 6, and 7, such an interference fit will exist at one or more contact surfaces between backup ring 20 (i.e., channel-directed face(s) 62 thereof) and buffer seal 18 (i.e., contoured face portion 44).

Each of the embodiments shown in FIGS. 3-7 is supplied with a seal apex 68 on outer surface seal face 38 of buffer seal 18 that is configured for creating a sealing point, with base surface 48 of seal gland 32. Seal apex 68 acts as a stress concentration point which in turn causes an increased localized pressure at the seal apex 68 for achieving greater sealing with seal gland 32.

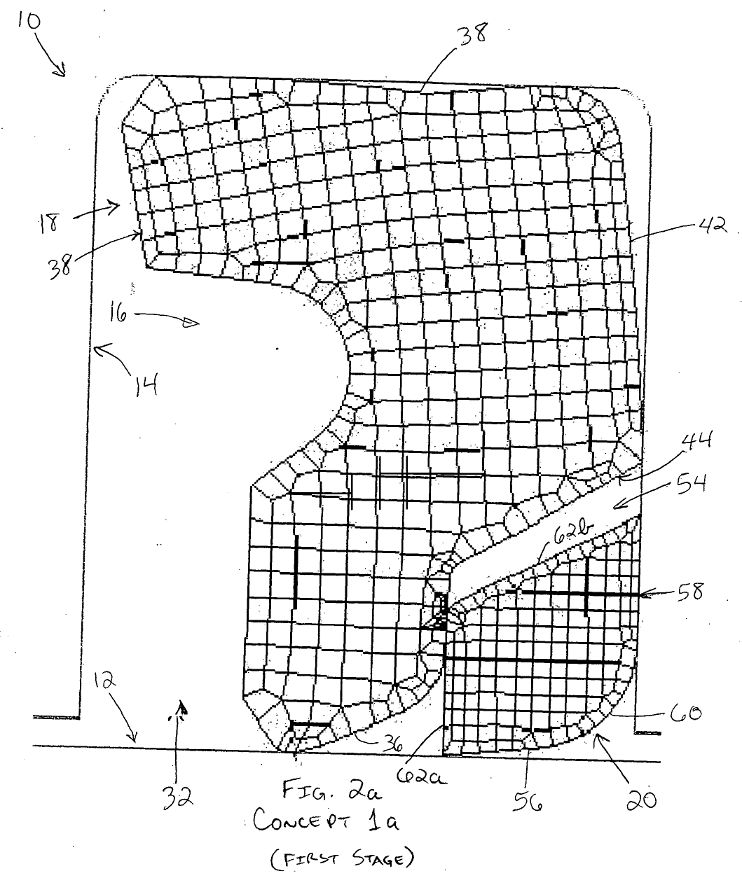

In the embodiment of FIG. 4, one of channel-directed faces 62 of backup ring 20 is a pronounced lip 70. Correspondingly, contoured face portion 44 of buffer seal 18 is provided with a mating lip-receiving chamfer 72. This lip and chamfer combination helps to assure that an absence of point loading forces occur between buffer seal 18 and backup ring 20 within that region, thereby promoting even pressure distribution as pressure is applied to back pumping seal assembly 16.

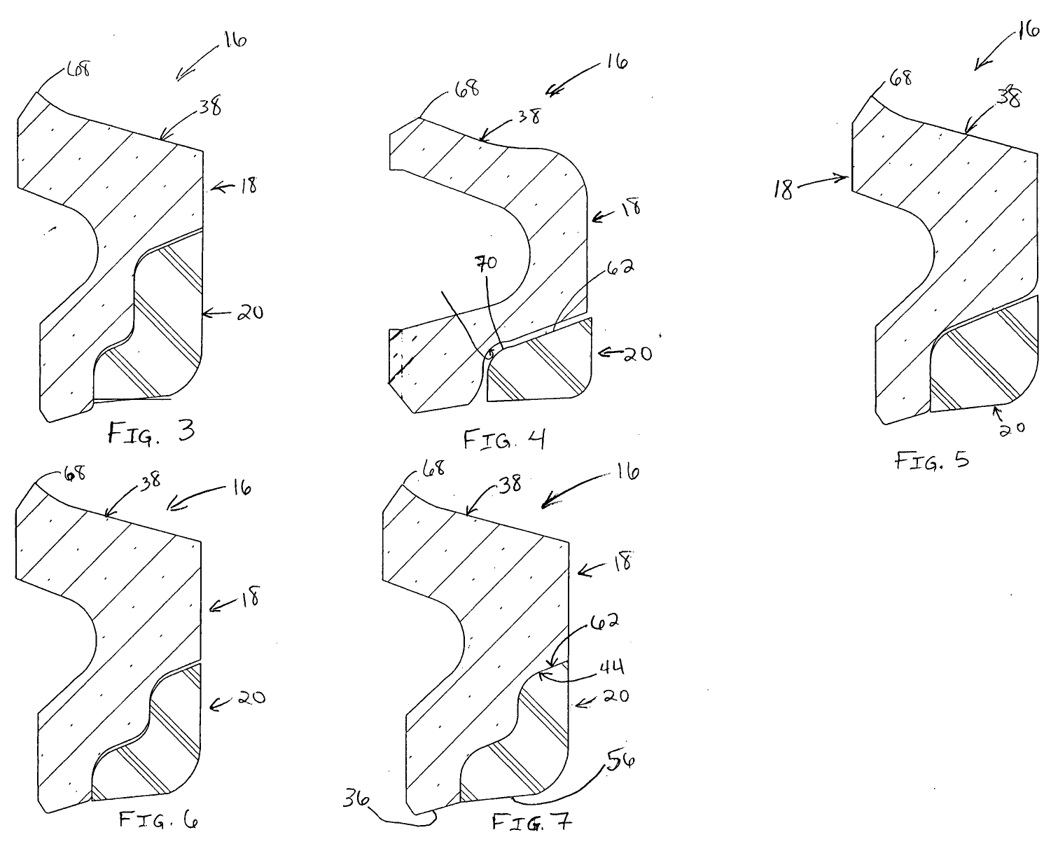

FIG. 7 illustrates that it is within the scope of the invention to have complete contact between channel-directed faces 62 of backup ring 20 and contoured face portion 44 of buffer seal 18 upon mounting within a seal gland 32 (i.e., the system having no initial clearances to act as pressure relief mechanisms). Even though there are no clearances, the effect of the other stress relief and stress management features of the present invention still apply to the embodiment of FIG. 7. Another feature associated with FIG. 7 is the fact that inner seal face of buffer seal 18 and inner ring face 56 of backup ring 20 form an essentially smooth and continuous intersection therebetween, such an intersection thereby promoting low stress concentration thereat.

The materials and seal geometries of the present invention can be designed to best facilitate the required seal performance. The seal design technique of the present invention can be applied to multiple applications and not just linear fluid power. For example, the friction reduction achieved with the present invention can be very useful for applications that have high surface velocities or other applications where seal surface heat generation becomes detrimental. The issue of heat generation can be very applicable in rotary applications. The improved back-pumping along with pressure relief characteristics of the present invention can provide improved performance to many common seal designs.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A back pumping seal assembly, comprising:
a buffer seal having an inner seal face, a front seal face, and a back seal face, said buffer seal further having a contoured face portion inset and extending inwardly from said inner seal face and said back seal face, said contoured face defining a back seal channel; and
a backup ring positioned in said back seal channel of said buffer seal, said backup ring including an inner ring face, a back ring face, and at least two channel-directed faces, said inner ring face and said back ring face being adjacent said inner seal face and said back seal face, respectively, a first said channel-directed face extending from said inner ring face in a direction substantially parallel to said back ring face, said first said channel-directed face being configured for limiting displacement of an adjacent portion of said buffer seal, a second said channel-directed face extending from said back ring face at an acute angle relative thereto.

2. The back pumping seal system of claim 1, wherein said buffer seal is composed of an elastomeric material.

3. The back pumping seal system of claim 1, wherein both said buffer seal and said backup ring are annular in shape.

4. The back pumping seal system of claim 1, wherein said buffer seal is composed of a first material, said backup ring being composed of a second material, said first material being more elastic than said second material, said second material being stronger than said first material.

5. The back pumping seal system of claim 1, wherein said buffer seal and said backup member are one of separate from one another, bonded together, and co-produced.

6. The back pumping seal system of claim 1, wherein the back pumping seal system is configured so as to be able to relieve sealing pressure primarily through back pumping under said inner seal face of said buffer seal and said inner ring face of said backup ring.

7. The back pumping seal system of claim 1, wherein said inner ring face and said back ring face are connected via a chamfered corner ring surface.

8. The back pumping seal system of claim 7, wherein said chamfered corner ring surface has a chamfer radius, said chamfer radius being sufficient so as to promote the formation of a fluid film for back pumping, said fluid film being formed proximate at least one of said inner ring face and said chamfer corner ring surface.

9. The back pumping seal system of claim 1, wherein said inner ring surface is positioned at a first acute angle relative to said first said channel-directed face, said first acute angle being nearly 90°.

10. The back pumping seal assembly of claim 9, wherein said first acute angle is less than 90° and greater than about 80°.

11. The back pumping seal assembly of claim 9, wherein said inner ring surface is angularly positioned relative to said first said channel-directed face in a manner so as to provide an optimal contact stress interface with an adjoining machine member relative to which said back pumping seal assembly is located.

12. The back pumping seal system of claim 1, wherein said backup ring is positioned and configured such that, under no-to-low pressure conditions, a substantial amount of said inner ring surface is out of contact with an adjacent machine member relative to which said back pumping seal assembly is located, thereby providing an initial clearance between at least a significant portion of said inner ring face and the adjacent machine member.

13. The back pumping seal assembly of claim 12, wherein the provision of said initial clearance permits some displacement of said backup ring at least under no-to-low load conditions, said displacement providing for an absorption energy via hoop stress.

14. The back pumping seal assembly of claim 1, wherein said backup ring has a ring cross-section, said ring cross-section being chosen so as permit at least one of tilting and rotation of said backup ring under high pressure conditions.

15. The back pumping seal assembly of claim 14, wherein said backup ring is thicker proximate said back ring face than proximate said front ring face, said backup ring thereby being configured for both resisting extrusion of said buffer seal and maintaining an optimal contact stress profile in an area of said backup ring.

16. The back pumping seal assembly of claim 1, wherein said backup ring has at least four said channel-directed faces, said backup ring having a generally L-shaped cross-section.

17. The back pumping seal assembly of claim 1, wherein, under no-to-low load pressure conditions, an intraseal clearance exists between a significant portion of at least one said channel-directed face and a respective adjacent portion of said buffer seal.

18. A machine assembly, comprising:
a first machine member, said first machine member having an outer surface;
a second machine member having a member receiving opening therein, said first machine member being mounted within said member receiving opening, said second machine member further having a seal receiving channel therein, said seal receiving channel extending inwardly into said second machine member from a location within said member receiving opening; and
a back pumping seal assembly operatively positioned within said seal receiving channel, said back pumping seal assembly creating a working seal between said first machine member and said second machine member, said back pumping seal assembly, comprising:
a buffer seal having an inner seal face, a front seal face, and a back seal face, said buffer seal further having a contoured face portion inset and extending inwardly from said inner seal face and said back seal face, said contoured face defining a back seal channel, said inner seal face being directed toward said outer surface of said first machine member; and
a backup ring positioned in said back seal channel of said buffer seal, said backup ring including an inner ring face, a back ring face, and at least two channel-directed faces, said inner ring face and said back ring face being adjacent said inner seal face and said back seal face, respectively, a first said channel-directed face extending from said inner ring face in a direction substantially parallel to said back ring face, said first said channel-directed face being configured for limiting displacement of an adjacent portion of said buffer seal, said inner ring face being directed toward said outer surface of said machine member a second said channel-directed face extending from said back ring face at an acute angle relative thereto.

19. The machine assembly of claim 18, wherein said first said channel-directed face is substantially perpendicular to said outer surface of said first machine member.
